(19) United States
(12) Patent Application Publication
(10) Pub. No.: US 2010/0045882 A1
(43) Pub. Date: Feb. 25, 2010

(54) TREATMENT APPARATUS THAT EMITS LIGHT FLASHES AND INCLUDES AN ANTI-GLARE DEVICE

(75) Inventor: Georges Safraoui, Villejust (FR)

Correspondence Address: Oliff & Berridge, PLC, P.O. Box 320850, Alexandria, VA, 22320-4850, US

(73) Assignee: EUROFEEDBACK, Evry (FR)

(21) Appl. No.: 12/515,908

(22) PCT Filed: Dec. 13, 2007
(86) PCT No.: PCT/FR07/52503

§ 371 Date: Jul. 24, 2009

(30) Foreign Application Priority Data
Dec. 14, 2006 (FR) 0655508

(51) Int. Cl. G02F 1/1335

(52) U.S. Cl. 349/14

(57) ABSTRACT

An apparatus for treating a human body or an animal body, which emits light flashes and comprises: a main post, a handpiece connected to the main post and including a flash lamp, a flash emission actuation member, and an individual portable system that protects against glare caused by the emission of a flash, said system comprising one or more optical occluders which are placed in front of the eyes and which can switch from a first optically transparent state to a second optical attenuation state. The+ main post can detect a user's action on the aforementioned actuation member and the occluders switch from the first state to the second state upon detection of one such action.

The present invention relates to items of apparatus for treatment by the emission of light flashes.

Such items of apparatus are used notably for therapeutic or nontherapeutic treatments, for example epilation or vascular or anti-aging treatments.

These items of apparatus comprise a base station and a handpiece connected to the base station, comprising a flash lamp.

A member for triggering the emission of the flashes is provided on the handpiece.

In practice, the treated subject usually wears partially or completely opaque spectacles, such as for example metal shells. The operator needs to maintain a good view in order to be able to carry out a treatment of quality. This work may last hours and be repeated every day. Since the flashes of incoherent light emitted by the handpieces are reflected, they may eventually tire the operator.

One solution may consist in using spectacles which attenuate the light over the whole emission spectrum. The pupils dilate in order to see better; such protection may however not be entirely satisfactory.

In addition, there is the risk that a flash is emitted when the handpiece is not applied against the region to be treated, for example in the direction of the treated subject.

To remedy this problem, it has been proposed to furnish the handpiece with a sensor sensitive to contact of the handpiece against the treated region, in order to authorize the emission of a flash only after this contact has been detected.

Such a solution makes the mechanical production of the handpiece more complex and does not remove the risk of dazzling the operator with the light which may be emitted by the handpiece despite its application against the region to be treated.

Furthermore spectacles for protection against glare caused by the emission of a flash are known which comprise a phototransistor and an optical occluder which may switch from a first optically transparent state to a second optical attenuation state in response to the detection by the phototransistor of a light pulse edge.

These spectacles have a response time between the moment when the light pulse edge is detected by the phototransistor and the moment when the occluder switches to the optical attenuation state which may be too great and therefore inappropriate in certain situations, for example when a succession of short flashes is emitted by the handpiece, which is the case in certain treatments.

Consequently there is a need to find a satisfactory solution to the problem of glare caused by the use of treatment apparatus by the emission of light flashes.

The object of the invention is to respond to this need and it does so by virtue of an apparatus comprising:
a base station,
a handpiece connected to the base station, comprising a flash lamp,
a member for triggering the emission of the flashes,
a personal portable system for protection against glare caused by the emission of a flash, comprising one or more optical occluders to be positioned in front of the eyes and being able to switch from a first optically transparent state to a second optical attenuation state,
   in which apparatus an action of the user on the triggering member is detected by the base station and in which the transition from the first state to the second state takes place in response to the detection of this action.

“Personal portable system for protection against glare caused by the emission of a flash” means any apparatus designed to protect the eyes, namely spectacles, a visor, a helmet or a mask.

“Optically transparent state” should be understood to be a state in which the occluder allows the user to see through the protection system.

“Optical attenuation state” should be understood to be a state in which the attenuation caused by the protection system makes it possible to reduce the glare.

The duration of emission of a flash following the detection of the action of the user on the triggering member may be less than or equal to 500 ms.

The base station may be arranged so that the emission of a flash takes place only after a predetermined delay, for example of between 0 and 50 ms, in order to allow the transition from the first state to the second state.

As a variant, the base station may be arranged so that the emission of a flash takes place a few ms before the transition from the first state to the second state.

The base station may also be arranged in order to allow the emission of a burst of flashes starting from the detection of the action of the user on the triggering member and in order to keep the occluder(s) in the second state for at least the duration of the burst of flashes.

This burst of flashes may be emitted at a frequency of between 5 and 500 Hz, for example.

In an exemplary embodiment of the invention, the base station may be arranged to allow a return to the first optically transparent state of the occluder(s) shortly before the end of the flash, which may make it possible to give the operator an indication concerning the emitted flash in total safety.

According to one embodiment, the protection system may comprise at least two parts, which may make it possible to lighten it.

The apparatus may be arranged so that the transmission between the protection system and the base station of an item of information commanding the transition from the first state to the second state takes place via a wire or wireless link.

According to one embodiment, the personal portable protection system comprises an accumulator and the base station may comprise a housing making it possible to accommodate the portable system when not in use and a means for recharging the accumulator.

The portable system may comprise a sensor arranged to detect whether it is being worn by the user, the portable system being arranged to inform the base station when the sensor detects that the portable system is being worn by the user.

The base station may be arranged so as to allow the emission of the flashes only after detection of a signal transmitted by the portable system corresponding to the wearing of the latter by the user.

The personal portable protection system may be arranged to signal to the base station that the accumulator is insufficiently charged.

The base station may be arranged so as to allow the emission of the flashes only after detection of a signal transmitted by the portable system corresponding to a state of sufficient charge of the accumulator.

The apparatus may be arranged to prevent the emission of light flashes while the occluder or occluders is/are not in the second state.

The base station may be arranged to allow the emission of the flashes only after detection of a signal transmitted by the portable system, corresponding to the transition of the occluder(s) to the second state.

In one exemplary embodiment of the invention, the optical attenuation state can be adjusted by the user or automatically, depending for example on the treatment selected by the user.

The base station may be arranged to send the protection system a signal for adjusting the intensity of attenuation or the quantity of light authorized by the opening of the occluder for a very short time of the flash, at the beginning or at the end of the flash, so that the operator keeps a protected view of the events.

A further object of the invention is a method for protecting the operation of an apparatus for treating the human or animal body by emission of light flashes, comprising the successive steps consisting in:
detecting an action taken by an operator on a member for triggering the emission of the flashes,
causing one or more optical occluders of a personal portable protection system, placed in front of the eyes of the operator, to switch from a first optically transparent state to a second optical attenuation state,
authorizing the emission of one or more light flashes.

The step of emission of the light flashes may be conditional upon the receipt of a signal originating from the personal portable protection system representative of the actual transition of the occluder(s) to the second optical attenuation state.

The actual wearing of the personal protection system may be detected and a message may be emitted if the wearing of said system is not detected and/or the emission of the light flashes may be prevented.

A burst of flashes may be emitted following an action on the member for triggering the emission of the flashes, notably a burst of flashes emitted at a frequency of between 5 and 500 Hz.

The invention may be better understood on reading the following detailed description, of nonlimiting exemplary embodiments of the latter and of the appended drawing in which:

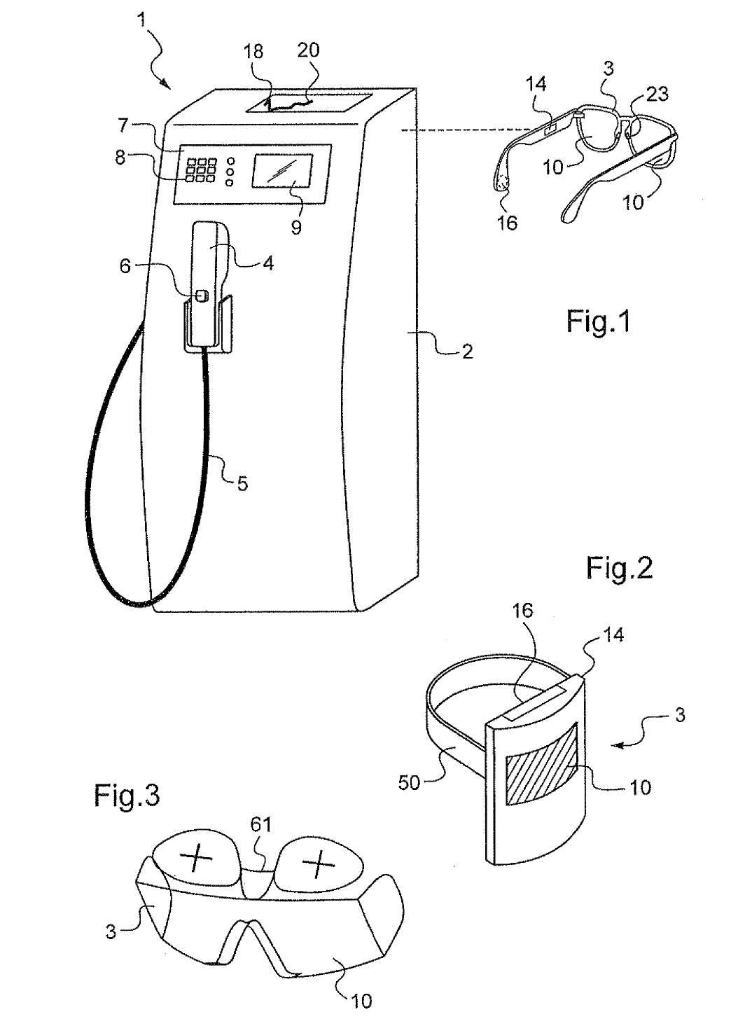

FIG. 1 is a schematic representation of a first exemplary embodiment according to the invention,

FIGS. 2 and 3 represent other exemplary embodiments according to the invention, comprising various personal portable protection systems against the glare caused by the emission of a flash,

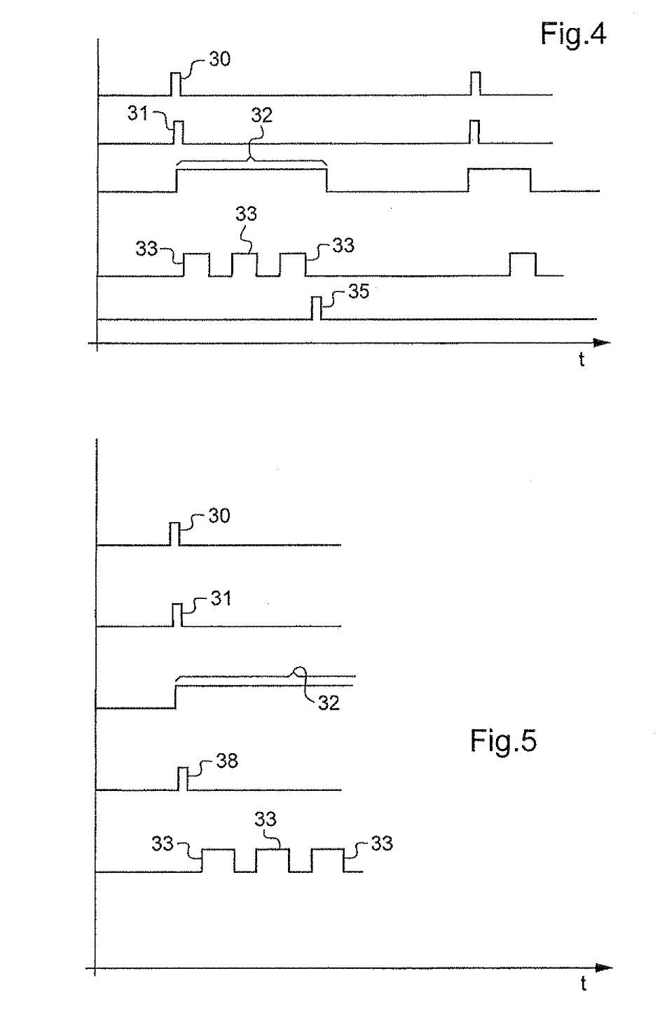

FIGS. 4 and 5 are timing charts illustrating the possible relationships between various signals according to two exemplary embodiments of the invention.

The apparatus 1 shown in FIG. 1 comprises a base station 2 and a personal portable protection system 3 against the glare caused by the emission of a flash.

This system 3, in the example of FIG. 1, is in the form of spectacles 3 designed to be worn by the operator during the use of the apparatus.

The apparatus 1 also comprises a handpiece 4 which is connected to the base station 2 via a cable 5.

The handpiece 4 comprises a member 6 for triggering the emission of the light flashes, which is shown for example in the form of a button which the user presses to trigger the emission of light flashes.

This button 6 may be situated in any suitable location on the handpiece 4, for example on the back of the latter or on the side of the face for the output of the light or elsewhere.

The invention is not limited to a triggering member having the shape of a button and the triggering member may for example comprise a sensitive key or any other switch sensitive to an action of the user.

The handpiece 4 incorporates at least one flash tube and an optical guide. An example of a handpiece is described in patent application FR 2 876 022.

The base station 2 comprises an electric generator supplying the energy necessary to emit the light flashes and a control panel 7 which comprises for example a keypad 8 or any other selection means allowing the user to select a type of treatment.

The control panel 7 may comprise a screen 9 on which information is displayed for informing the user on, for example, the selected treatment.

The base station 2 also comprises means making it possible to transmit, or even to interchange, information with the protection system 3.

The base station 2 may comprise for example means making it possible to establish a wireless link with the protection system 3, for example a radiofrequency or infrared link.

The base station 2 may therefore comprise a radiofrequency emitter making it possible to transmit information preferably in a coded manner, and the protection system 3 may comprise a receiver suitable for receiving this information.

The protection system 3 comprises one or more optical occluders 10, for example two liquid crystal occluders each placed in front of an eye, which may switch from a first optically transparent state to a second optical attenuation state.

The protection system 3 also comprises an electronic circuit 14 which, on the one hand, makes it possible to receive information from the base station 2 and, on the other hand, to command the transition of the occluder(s) 10 from the first state to the second state and vice versa.

The electronic circuit 14 may also be arranged to transmit information to the base station 2, as will be specified below.

The protection system 3 may comprise any source of electric energy making it possible to operate the electronic circuit 14, for example an accumulator 16 which may be incorporated, for example in one of the branches in the example illustrated in FIG. 1.

The base station 2 may comprise a housing 18 for accommodating the protection system 3 when not in use.

The base station 2 may comprise a connector 20 which may be connected to the protection system 3 when the latter is in place in the housing 18, in order to recharge the accumulator 16.

The connector 20 may take various forms and the protection system 3 may have any appropriate means of connection to the connector 20.

In one variant, the recharging of the accumulator 16 takes place without physical connection, for example by means of an inductive coupling, the protection system 3 comprising for example a coil making it possible to generate an electric voltage when exposed to an electric current and to a variable magnetic field generated by a coil of the base station 2,

In one variant, the protection system 3 comprises a housing for accommodating batteries.

In another variant, the protection system 3 is connected via a cable to the base station 2, this cable ensuring the circulation of the current necessary to operate the optical occluder(s) 10 and, if necessary allowing the transmission of information originating from one or more sensors present on the protection system 3 to the base station 2.

In a further variant, the protection system 3 is connected by wires to a portable module, for example to be clipped to the belt or to be placed in a garment pocket.

This portable module may comprise the electronic circuit 14 and the accumulator or any other source of energy making it possible to operate the electronic circuit 14. Such a device may make it possible to obtain a protection system 3 having a lighter part worn on the head.

If necessary, the protection system 3 comprises a sensor 23 which makes it possible to detect whether it is being worn by the user.

This sensor 23 may for example take the form of a resistive sensor placed so as to detect a variation of impedance between two electrodes when the protection system 3 is in place on the user.

The sensor 23 may also be a heat sensor which makes it possible to detect a local rise in temperature when the protection system 3 is worn by the user.

Other sensors 23 can be envisorged, for example optical, capacitive or mechanical sensors.

In the presence of the sensor 23, the protection system 3 is arranged not only to receive information from the base station 2 but also to transmit thereto information originating from the sensor 23, representative of the fact that the protection system 3 is being worn by the user.

Other information may also be transmitted to the base station by the protection system 3, for example information representative of the state of charge of the accumulator or of any other energy source, or else information representative of the actual transition of the optical occluder(s) 10 to the optical attenuation state.

This actual transition is for example detected by a photoelectric cell.

The invention is not limited to one particular form of protection system and in one exemplary embodiment, the latter takes the form of a visor, as illustrated in FIG. 2, which may for example comprise only one occluder 10. The visor may for example be kept on the user's head by means of a headband 50 or similar element.

FIG. 3 partially represents another variant in which the protection system 3 is arranged to be attached to existing spectacles 61, for example sight-correction spectacles.

In one exemplary embodiment of the invention, when the user presses on the triggering member 6, a corresponding signal 30 is generated, as illustrated in FIG. 4.

The base station 2 may be arranged so that only a predetermined number of flashes is emitted when the triggering member 6 is pressed, irrespective of how long this pressure is applied.

The signal 30 is detected by the base station 2 which transmits to the protection system 3 an item of command information 31 to change the state of the occluder(s) 10, from the optically transparent state to the optical attenuation state. The latter is provided by a signal 32 sent to the occluder(s) 10.

The electronic signal 14, on receipt of this command signal 31, causes the change of state of the occluder(s) 10 by applying the corresponding voltage 32 thereto.

The base station 2, after transmission of the occlusion command signal 31, authorizes the emission of the light flashes according to the treatment program selected by the user. A signal 33 for commanding the emission of the flashes is therefore generated, this signal being able to comprise several pulses corresponding to the emission of a burst of flashes.

Once the flash or flashes have been emitted, the base station can send to the protection system 3 a signal 35 causing the change of state of the occluder(s) 10 which return to the optically transparent state.

In the variant of FIG. 5, the protection system 3 is arranged to interchange information with the base station 2 and notably to transmit to the latter a signal 38 representative of the actual transition of the occluder(s) 10 to the optical attenuation state.

This may constitute additional safety. The base station 2 verifies the receipt of this information 38 before generating the signal 33 to command the emission of the flashes.

Naturally, the invention is not limited to the examples that have just been described.

In particular, the occluder(s) 10 may be of any type, being for example other than liquid crystals, for example with an electromechanical diaphragm.

In one variant embodiment, the optical attenuation state may be adjustable, for example by the user, who may for example enter on the control panel 7 information making it possible to adjust the attenuation factor or the desired delay with which a flash is emitted after the transition from the first to the second state of the occluder.

This adjustment may also be made automatically according, for example, to the treatment selected by the user.

The intensity of attenuation may also optionally be adjusted on the portable system itself.

If necessary, a second protection system may be used with the same base station, this system being worn by the treated subject.

“Comprising a” must be understood as being synonymous with “comprising at least one”, unless it is specified to the contrary. “Of between” is understood to mean inclusive of the limits.

1. An apparatus for treating a human or animal body by emission of light flashes, comprising:
a base station,
a handpiece connected to the base station, comprising a flash lamp,
a member for triggering the emission of the flashes,
a personal portable system for protection against glare caused by the emission of a flash, comprising one or more optical occluders to be positioned in front of eyes and being configured to be switchable from a first optically transparent state to a second optical attenuation state,
wherein the base station is configured to detect an action of a user on the triggering member and wherein a transition from the first state to the second state takes place in response to a detection of the action.

2. The apparatus as claimed in claim 1, the base station being configured to delay the emission of a flash between 0 and 50 ms after the detection of the action.

3. The apparatus as claimed in claim 1, the base station being configured so that the emission of a flash takes place before the transition from the first state to the second state.

4. The apparatus as claimed in claim 1, the base station being configured to allow a return to the first optically transparent state of the at least one occluder before an end of the flash.

5. The apparatus as claimed in claim 1, the base station being configured to allow the emission of a burst of flashes starting from the detection of the action of the user on the triggering member to keep the at least one occluder in the second state for at least a duration of the burst of flashes.

6. The apparatus as claimed in claim 5, the burst of flashes being emitted at a frequency of between 5 and 500 Hz.

7. The apparatus as claimed in claim 1, a duration of emission of a flash following the detection of the action of the user on the triggering member being less than or equal to 500 ms.

8. The apparatus as claimed in claim 1, comprising a wireless link configured to transmit between the protection system and the base station an item of information commanding the transition from the first state to the second state.

9. The apparatus as claimed in claim 1, the protection system comprising an accumulator and the base station comprising a housing configured to allow an accommodation of the protection system and a charger for recharging the accumulator.

10. The apparatus as claimed in claim 1, the protection system comprising two parts.

11. The apparatus as claimed in claim 1, the protection system comprising a sensor for sensing a wearing of the system by the user, the system being configured to inform the base station when the sensor detects that the portable system is being worn by the user.

12. The apparatus as claimed in claim 9, the portable system being configured to signal to the base station that the accumulator is insufficiently charged.

13. The apparatus as claimed in claim 1, the apparatus being configured to prevent the emission of light flashes while the at least one occluder is not in the second state.

14. A protection method for the operation of the apparatus of claim 1 for treating the human or animal body by emission of light flashes, comprising:
detecting an action taken by an operator on a member for triggering the emission of the flashes,
causing one or more optical occluders of the personal portable protection system, placed in front of the eyes of the operator, to switch from a first optically transparent state to a second optical attenuation state, and
authorizing the emission of one or more light flashes.

15. The method as claimed in claim 14, the emitting the light flashes being conditional upon the receipt of a signal originating from the personal portable protection system representative of actual switching of the at least one occluder to the second optical attenuation state.

16. The method as claimed in claim 14 wherein an actual wearing of the personal portable protection system is detected and wherein a message is emitted if the wearing of said system is not detected and/or the emission of the light flashes is prevented.

17. The method as claimed in claim 14, wherein a burst of flashes is emitted following an action on the member for triggering the emission of the flashes.
